(19) United States
(12) Patent Application Publication
(10) Pub. No.: US 2006/0142159 A1
(43) Pub. Date: Jun. 29, 2006

(54) Plant-protective agents in the form of suspensions

(76) Inventors: Gerd Roland Meyer, Frankfurt am Main (DE); Ralf Zerrer, Karlstein (DE); Roman Morschhaeuser, Mainz (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/500,026

(22) PCT Filed: Dec. 17, 2002
(86) PCT No.: PCT/EP02/14365

§ 371 Date: Feb. 25, 2005

(30) Foreign Application Priority Data
Dec. 22, 2001 (DE) 101 63 888.4

(51) Int. Cl. A01N 25/10; A01N 25/00

(52) U.S. Cl. 504/116.1; 504/360

(57) ABSTRACT

Aqueous plant protection formulations in the form of suspensions The invention relates to aqueous plant protection formulations in the form of suspensions comprising polymers based on acrylamidopropyl-methylenesulfonic acid (AMPS) and “macromonomers”. The suspensions show high compatibility and suspensibility of the components (pesticides, adjuvants, dispersing agents, electrolytes, and the like). The invention is particularly suitable for suspension concentrates. The suspension concentrates show high stability on storage.

The present invention relates to plant protection formulations in the form of suspensions comprising polymers based on acrylamidopropylmethylene-sulfonic acid (AMPS) and “macromonomers”. A high suspensibility of the individual components (pesticides, adjuvants, and the like) is achieved by addition of the polymers.

It is often observed, in plant protection formulations in the form of suspensions, that only an unsatisfactory suspensibility, i.e. the ability to remain suspended, of the individual components (pesticides, adjuvants, and the like) is obtained. In particular, this deficiency is observed in suspension concentrates, which often only show an unsatisfactory storage stability. Moreover, on diluting suspension concentrates to the desired spray strength, it is frequently observed that gel formation, phase separation, crystallization or sedimentation of the individual components occurs. The consequence of this is a restricted variety of formulations, a loss in effectiveness of the active substances, the danger of the filter systems and nozzle systems blocking, and a high expenditure on purification.

One of the reasons for the abovementioned problems is that the individual components are generally poorly compatible with one another, which is very noticeable in particular at high concentrations. Thus, e.g., pesticides with predominantly hydrophobic groups are sparingly soluble in water and poorly compatible with other pesticides or adjuvants, dispersing agents and electrolytes.

It has now been found, surprisingly, that aqueous plant protection formulations in the form of suspensions comprising at least one polymer based on acrylamidopropylmethylenesulfonic acid (AMPS) and “macro-monomers” show high compatibility of the components (pesticides, adjuvants, dispersing agents, electrolytes, and the like) with one another and high suspensibility (ability to remain suspended) of the components. In addition, suspension concentrates show high storage stability.

The present invention accordingly relates to aqueous plant protection formulations in the form of suspensions comprising at least one polymer which can be prepared by radical copolymerization of

A) acrylamidopropylmethylenesulfonic acid (AMPS) and/or its salts;

B) one or more macromonomers comprising
i) a terminal group which is capable of polymerizing and which is at least partially soluble in the reaction medium,
   ii) a hydrophobic part which is hydrogen or a saturated or unsaturated, linear or branched, aliphatic, cycloaliphatic or aromatic (C1-C₁₀₀)-hydrocarbon residue, and
iii) optionally a hydrophilic part based on polyalkylene oxides; and

C) optionally one or more other at least mono- or polyolefinically unsaturated oxygen-, nitrogen-, sulfur-, phosphorus-, chlorine- and/or fluorine-comprising comonomers.

The macromonomers B) preferably comprise a hydrophilic part based on polyalkoxides, preferably polyethylene oxides and/or polypropylene oxides.

Suitable salts of acrylamidopropylmethylenesulfonic acid (AMPS) are preferably the lithium, sodium, potassium, magnesium, calcium, ammonium, monoalkylammonium, dialkylammonium, trialkylammonium or tetraalkylammonium salts, the alkyl substituents of the ammonium ions being, independently of one another, (C₁-C₂₂)-alkyl residues which can carry 0 to 3 hydroxyalkyl groups, the alkyl chain length of which can vary within a range from C₂ to C₁₀. Mono- to triethoxylated ammonium compounds with a variable degree of ethoxylation are likewise suitable.

The sodium and ammonium salts are particularly preferred as salts.

The degree of neutralization of the acrylamidopropylmethylenesulfonic acid (AMPS) is preferably 70 to 100 mol %.

The comonomer A) is preferably the sodium salt and/or ammonium salt of acrylamidopropylmethylenesulfonic acid (AMPS).

The macromonomers B) are preferably those of the formula (1)
R¹—Y—(R²—O)ₓ(R⁴—O)_{z}—R³ (1)
in which
R¹ is a vinyl, allyl, acryloyl (i.e. CH₂═CH—CO—), methacryloyl (i.e. CH₂═C(CH₃)—CO—), senecioyl or crotonyl residue;
R² and R⁴ are, independently of one another, (C₂-C₄)-alkylene;
x and z are, independently of one another, an integer between 0 and 500, preferably with x+z greater than or equal to 1;
Y is O, S, PH or NH, preferably O; and
R³is hydrogen or a saturated or unsaturated, linear or branched, aliphatic, cycloaliphatic or aromatic (C₁-C₁₀₀)-hydrocarbon residue, preferably (C₁-C₃₀)-hydrocarbon residue.

R¹ is particularly preferably an acryloyl or methacryloyl residue, R² and R⁴ are particularly preferably a C₂- or C3-alkylene residue.

Particularly preferably, x and z are, independently of one another, a number between 0 and 50, preferably with x+z greater than or equal to 1.

Especially preferably, 5≦x+z≦50 applies.

R³ is particularly preferably an aliphatic (C₄-C₂₂)-alkyl or -alkenyl residue, preferably (C₁₀-C₂₂)-alkyl or -alkenyl residue; a phenyl residue; a (C₁-C₂₂)-alkylphenyl residue, preferably (C₁-C₉)-alkylphenyl residue, particularly preferably (C₁-C₄)-alkylphenyl residue, especially preferably sec-butyl- or n-butylphenyl residue; a poly((C₁-C₂₂)-alkyl)phenyl residue, preferably poly((C₁-C₉)-alkyl)phenyl residue, particularly preferably poly((C₁-C₄)-alkyl)phenyl residue, especially preferably poly(sec-butyl)phenyl residue, very particularly preferably tris(sec-butyl)phenyl residue or tris(n-butyl)phenyl residue; or a polystyrylphenyl residue [i.e. poly(phenylethyl)phenyl residue], particularly preferably tristyrylphenyl residue [i.e. tris(phenylethyl)phenyl residue].

Preference is especially given, as R³ residues, to 2,4,6-tris(1-phenylethyl)phenyl residues and 2,4,6-tris(sec-butyl)phenyl residues.

The macromonomers B) are preferably prepared by reaction of reactive derivatives of unsaturated carboxylic acids, preferably of methacrylic or acrylic acid, with the corresponding, optionally alkoxylated, alkyl or aryl residues comprising hydroxyl groups. The ring-opening addition to the respective carboxylic acid glycidyl esters is also possible.

In a preferred embodiment, the polymers additionally comprise other olefinically unsaturated oxygen-, nitrogen-, sulfur-, phosphorus-, chlorine- and/or fluorine-comprising comonomers C).

Preference is given, as comonomers C), to olefinically unsaturated acids or heir salts, preferably with mono- and divalent counterions, particularly preferably styrenesulfonic acid, vinylsulfonic acid, vinylphosphonic acid, allylsulfonic acid, methallylsulfonic acid, acrylic acid, methacrylic acid and/or maleic acid or maleic anhydride, fumaric acid, crotonic acid, itaconic acid or senecioic acid or their salts. Preferred counterions are Li⁺, Na⁺, K⁺, Mg²⁺, Ca²⁺, Al³⁺, NH⁴⁺, monoalkylammonium, dialkylammonium, trialkylammonium and tetraalkylammonium ions, in which the substituents of the amines are, independently of one another, (C₁-C₂₂)-alkyl residues which can carry 0 to 3 hydroxyalkyl groups, the alkyl chain length of which can vary within a range from C₂ to C₁₀. In addition, mono- to triethoxylated ammonium compounds with a variable degree of ethoxylation, and corresponding acid anhydrides (also mixed), can also be used. The degree of neutralization of the optional olefinically unsaturated acids C) can be 0 to 100 mol %, preferably 70 to 100 mol %.

Also suitable as comonomers C) are esters of unsaturated carboxylic acids, preferably acrylic acid, methacrylic acid, styrenesulfonic acid, maleic acid, fumaric acid, crotonic acid and senecioic acid, with aliphatic, aromatic or cycloaliphatic alcohols with a carbon number of 1 to 30.

Suitable comonomers C) are likewise acyclic and cyclic N-vinylamides (N-vinyllactams) with a ring size of 4 to 9 atoms, preferably N-vinylformamide (NVF), N-vinylmethylformamide, N-vinylmethylacetamide (VIMA), N-vinyl-acetamide, N-vinylpyrrolidone (NVP), N-vinylcaprolactam; amides of acrylic acid and of methacrylic acid, particularly preferably acrylamide, N,N-dimethylacrylamide, N,N-diethylacrylamide, N,N-diisopropylacrylamide; alkoxylated acrylamides and methacrylamides, preferably hydroxymethylmethacrylamide, hydroxyethylmethacrylamide and hydroxypropylmethacrylamide.

Likewise suitable are succinic acid mono[2-(methacryloyloxy)ethyl ester]; N,N-dimethylamino methacrylate; diethylaminomethyl methacrylate; acryl- and methacrylamidoglycolic acid; [2-(methacryloyloxy)ethyl]trimethylammonium chloride (MAPTAC) and [2-(acryloyloxy)ethyl]trimethylammonium chloride (APTAC); 2-vinylpyridine; 4-vinylpyridine; vinyl acetate; methacrylic acid glycidyl ester; acrylonitrile; vinyl chloride; vinylidene chloride; tetrafluoroethylene; diallyldimethylammonium chloride (DADMAC); stearyl acrylate; and/or lauryl methacrylate.

Also suitable are methylenebisacrylamide and methylenebismethacrylamide; esters of unsaturated mono- and polycarboxylic acids with polyols, e.g. diacrylates or triacrylates, such as butanediol diacrylate or dimethacrylate, ethylene glycol diacrylate or dimethacrylate, and trimethylolpropane triacrylate; allyl compounds, e.g. allyl (meth)acrylate, triallyl cyanurate, maleic acid diallyl ester, polyallyl esters, tetraallyloxyethane, triallylamine, tetraallylethylenediamine, allyl esters of phosphoric acid; and/or vinylphosphonic acid derivatives.

Preference is particularly given, for use, to polymers which can be prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS);
B) one or more macromonomers chosen from the group of the esters formed from methacrylic acid or acrylic acid, preferably methacrylic acid, and compounds of the formula (2)
   HO—(CH₂—CH₂—O)ₓ—R³ (2)
   in which x is a number between 0 and 50, preferably 1 and 50, particularly preferably 5 and 30, and R³ is a (C₁₀-C₂₂)-alkyl residue; and
C) optionally one or more comonomers chosen from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate, preferably methacrylic acid and/or methacrylamide.

Macromonomers B) which are especially suitable are esters formed from acrylic acid or methacrylic acid and alkyl ethoxylates chosen from the group consisting of

(C₁₀-C₁₈)-fatty alcohol polyglycol ethers with 8 EO units (Genapol® C-080);

C₁₁-oxo alcohol polyglycol ethers with 8 EO units (Genapol® UD-080);

(C₁₂-C₁₄)-fatty alcohol polyglycol ethers with 7 EO units (Genapol® LA-070);

(C₁₂-C₁₄)-fatty alcohol polyglycol ethers with 11 EO units (Genapol® LA-110);

(C₁₆-C₁₈)-fatty alcohol polyglycol ethers with 8 EO units (Genapol® T-080);

(C₁₆-C₁₈)-fatty alcohol polyglycol ethers with 15 EO units (Genapol® T-150);

(C₁₆-C₁₈)-fatty alcohol polyglycol ethers with 11 EO units (Genapol® T-110);

(C₁₆-C₁₈)-fatty alcohol polyglycol ethers with 20 EO units (Genapol® T-200);

(C₁₆-C₁₈)-fatty alcohol polyglycol ethers with 25 EO units (Genapol® T-250);

(C₁₈-C₂₂)-fatty alcohol polyglycol ethers with 25 EO units;

iso(C₁₆-C₁₈)-fatty alcohol polyglycol ethers with 25 EO units; and

C₂₂-fatty alcohol polyglycol ethers with 25 EO units (Mergital® B-25).

In this connection, the EO units are ethylene oxide units. The Genapol® grades are products from Clariant and Mergital® B25 is a product from Cognis.

Particular preference is likewise given to polymers which can be prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS);
B) one or more macromonomers chosen from the group of the esters formed from acrylic acid or methacrylic acid, preferably methacrylic acid, and compounds of the formula (3)
   HO—(CH₂—CH₂—O)ₓ—R³ (3)
   in which
x is a number between 0 and 50, preferably 1 and 50, particularly preferably 5 and 30, and
R is a poly((C₁-C₂₂)-alkyl)phenyl residue, preferably tris(sec-butyl)phenyl residue or tris(n-butyl)phenyl residue, particularly preferably 2,4,6-tris(sec-butyl)phenyl residue, or a tris(styryl)phenyl residue, preferably 2,4,6-tris(1-phenylethyl)phenyl residue; and
C) optionally one or more comonomers chosen from acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate, preferably methacrylic acid and/or methacrylamide.

The proportion by weight of the macromonomers B) in the polymer can vary between 0.1 and 99.9% by weight. In a preferred embodiment, the polymers are highly hydrophobically modified, i.e. the proportion of macromonomers B) is 50.1 to 99.9% by weight, preferably 70 to 95% by weight, particularly preferably 80 to 94% by weight. In another preferred embodiment, the polymers are poorly hydrophobically modified, i.e. the proportion of macromonomers B) is 0.1 to 50% by weight, preferably 5 to 25% by weight, particularly preferably 6 to 20% by weight.

The monomer distribution of the monomers A), B) and C) in the polymers can be alternating, random, gradient or block (also multiblock). The number-average molecular weight of the polymers is preferably 1000 to 20 000 000 g/mol, preferably 20 000 to 5 000 000 g/mol, particularly preferably 50 000 to 1 500 000 g/mol.

In a preferred embodiment, the polymers are crosslinked, i.e. at least one crosslinking agent with at least two double bonds is copolymerized in the polymer.

Preferred crosslinking agents are methylenebisacrylamide and methylenebismethacrylamide; esters of unsaturated mono- or polycarboxylic acids with polyols, preferably diacrylates and triacrylates, e.g. butanediol diacrylate or dimethacrylate, ethylene glycol diacrylate or dimethacrylate, and trimethylolpropane triacrylate, allyl compounds, preferably allyl (meth)acrylate, triallyl cyanurate, maleic acid diallyl ester, polyallyl esters, tetraallyloxyethane, triallylamine, tetraallylethylenediamine, allyl esters of phosphoric acid; and/or vinylphosphonic acid derivatives.

The polymers can be prepared by radical copolymerization, e.g. precipitation polymerization, emulsion polymerization, solution polymerization or suspension polymerization.

Particularly suitable are polymers which were prepared by precipitation polymerization, preferably in tert-butanol.

Using precipitation polymerization in tert-butanol, a specific particle size distribution of the polymers can be obtained in comparison with other solvents. The size distribution of the polymer particle can, e.g., be determined by laser diffraction or sieve analysis. The following particle size distribution is representative of a convenient size distribution, the particle size distribution being, as was determined by sieve analysis: 60.2% less than 423 micrometers, 52.0% less than 212 micrometers, 26.6% less than 106 micrometers, 2.6% less than 45 micrometers and 26.6% greater than 850 micrometers.

The polymerization reaction can be carried out in the temperature range between 0 and 150° C., preferably between 10 and 100° C., both at standard pressure and under increased or reduced pressure. As usual, the polymerization can also be carried out in a protective gas atmosphere, preferably under nitrogen.

The polymerization can be initiated by high-energy electromagnetic radiation or the usual chemical polymerization initiators, e.g. organic peroxides, such as benzoyl peroxide, tert-butyl hydroperoxide, methyl ethyl ketone peroxide or cumene hydroperoxide, azo compounds, such as, e.g., azobisisobutyronitrile or azobisdimethylvaleronitrile, and inorganic peroxy compounds, such as, e.g., (NH₄)₂S₂O₈, K₂S₂O8 or H₂O₂, optionally in combination with reducing agents, such as, e.g., sodium hydrogensulfite and iron(II) sulfate, or redox systems comprising, as reducing component, an aliphatic or aromatic sulfonic acid, such as, e.g., benzenesulfonic acid, toluenesulfonic acid or derivatives of these acids, such as, e.g., Mannich adducts from sulfinic acid, aldehydes and amino compounds.

The polymers are readily soluble in water and are thermally stable. The adsorption behavior of the polymers with respect to water-insoluble active substances can in particular be adjusted by the choice of the monomers, the monomer distribution and the degree of crosslinking. In addition, the rheological properties of the suspensions can thus be adjusted.

It has been found, surprisingly, that the use of the polymers has a particularly advantageous effect in suspension concentrates. Suspension concentrates are highly concentrated suspensions which, when they are to be applied, are diluted with water to the desired spray strength. The dilution ratio in this connection preferably ranges from 10 to 1000, particularly preferably from 20 to 200. The compatibility and the suspensibility of the components, in spite of the high concentrations, are clearly increased by the use of the polymers. Furthermore, gel formation, phase separation, crystallization and/or sedimentation of the individual components on diluting is greatly reduced. Moreover, the storage stability of the suspension concentrates is increased.

The proportion of water in the suspension concentrates is, based on the ready-mix concentrates, preferably 10 to 50% by weight, particularly preferably 10 to 45% by weight, especially preferably 25 to 45% by weight.

The proportion of polymers in the suspension concentrates is, based on the ready-mix concentrates, preferably 0.01 to 10% by weight, particularly preferably 0.01 to 5% by weight, especially preferably 0.01 to 2.5% by weight, very particularly preferably 0.025 to 2.5% by weight.

In a preferred embodiment, the suspensions/suspension concentrates additionally comprise at least one dispersing agent.

In this connection, it has been found, surprisingly, that a synergistic effect occurs between the dispersing agents and the polymers which is manifested in that, in the presence of the dispersing agents, even a small amount of polymers is sufficient to markedly increase the suspensibility. The proportion of the dispersing agents is, based on the ready-mix suspension concentrates, preferably 0.5 to 10% by weight, particularly preferably 0.5 to 5% by weight, and the proportion of the polymers is, based on the ready-mix suspension concentrates, preferably 0.01 to 2.5% by weight, particularly preferably 0.025 to 1% by weight.

All conventional dispersing agents are suitable as dispersing agents.

Preference is given to phosphoric acid esters and their salts (e.g. potassium, sodium or triethanolamine salts) of fatty alcohols and their alkoxylates, preferably poly(arylalkyl)phenol polyethylene glycol phosphoric acid esters and tristyryl polyglycol ether phosphates; methoxycarbonylcellulose; methylcellulose; starch, alginates; sulfonated naphthalene/formaldehyde condensates; lignosulfonates; polyvinylpyrrolidone and/or polyvinyl alcohol.

The suspensions/suspension concentrates comprise, as defined, at least one pesticide. Suitable pesticides are preferably herbicides, insecticides, fungicides, acaricides, bactericides, molluscicides, nematicides and/or rodenticides.

The proportion of pesticides is, based on the ready-mix suspension concentrates, preferably 10-90% by weight, particularly preferably 30 to 60% by weight, especially preferably 40 to 50% by weight.

The invention is especially advantageous for suspensions/suspension concentrates which comprise hydrophobic pesticides which are sparingly soluble in water. Such pesticides exhibit a particularly marked tendency to agglomerate.

The term “sparingly soluble” describes pesticides having a solubility in water of less than 10 grams/liter, preferably less than 1 gram/liter.

The term “readily soluble” describes pesticides having a solubility in water preferably of greater than 100 grams/liter, particularly preferably of greater than 500 grams/liter, especially preferably of greater than 800 grams/liter. Mention may be made, as preferred sparingly-soluble pesticides, of those from the class of the azoles, e.g. propiconazole (1-[2-(2,4-dichlorophenyl)-4-propyl-1,3-dioxolan-2-ylmethyl]-1H-1,2,4-triazole) and tebuconazole ((RS)-1-(p-chlorophenyl)-4,4-dimethyl-3-(1H-1,2,4-triazol-1-ylmethyl)pentan-3-ol), of the sulfonates, e.g. ethofumesate and benfuresate, of the anilides, e.g. propanil, of the phenylurea derivatives, e.g. monuron, diuron (N′-(3,4-dichlorophenyl)-N,N-dimethylurea) and amitrole, of the triazines, e.g. simazine and atrazine (6-chloro-N-ethyl-N′-(1-methylethyl)-1,3,5-triazine-2,4-diamine), of the tetrazines, e.g. clofentezine (3,6-bis(2-chlorophenyl)-1,2,4,5-tetrazine), of the propionic acid derivatives, e.g. dalapon, of the carbamates, e.g. pyrazolinate, tebuconazole, hexaconazole, phenmedipham (3-[(methoxycarbonyl)amino]phenyl (3-methylphenyl)carbamate) and desmedipham, of the thiocarbamates, of the alkylenebis(dithiocarbamates), e.g. maneb ([1,2-ethanediylbis[carbamodithioato](2-)]manganese), mancozeb ([[1,2-ethanediylbis[carbamodithioato]](2-)]manganese and [[1,2-ethanediylbis[carbamodithioato]](2-)]zinc) and carbaryl (1 -naphthyl methylcarbamate), azoxystrobin (methyl (E)-2-[[6-(2-cyanophenoxy)-4-pyrimidinyl]oxy]-α-(methoxymethylene)benzeneacetate), linuron, trifluralin, metsulfuron-methyl (methyl 2-[[[[(4-methoxy-6-methyl-1,3,5-triazin-2-yl)amino]carbonyl]amino]sulfonyl]benzoate), triasulfuron (2-(2-chloroethoxy)-N-[[(4-methoxy-6-methyl-1,3,5-triazin-2-yl)amino]carbonyl]-benzenesulfonamide), tribenuron-methyl (methyl 2-[[[[(4-methoxy-6-methyl-1,3,5-triazin-2-yl)methylamino]carbonyl]amino]sulfonyl]benzoate) and chlorsulfuron (2-chloro-N-[[(4-methoxy-6-methyl-1,3,5-triazin-2-yl)amino]-carbonyl]benzenesulfonamide), of the halophthalonitriles, e.g. chlorothalonile (2,4,5,6-tetrachloro-1,3-dicyanobenzene), copper hydroxide and diflubenzuron (N-[[(4-chlorophenyl)amino]carbonyl]-2,6-difluorobenzamide).

In a preferred embodiment, the suspensions/suspension concentrates comprise mixtures of at least one sparingly soluble pesticide and at least one readily soluble pesticide, preferably chosen from glyphosate, sulfosate and glufosinate. The sparingly soluble pesticides and the readily soluble pesticides become compatible with one another through the presence of the copolymers.

Auxiliaries/additives which can be present in the suspensions/suspension concentrates include, inter alia, surface-active agents (adjuvants), solid carriers, antifoam agents, thickeners, antifreeze agents, evaporation retardants, preservatives, antigelling agents and neutralizing agents.

The proportion of surface-active agents is, based on the ready-mix suspension concentrates, preferably 10 to 50% by weight, particularly preferably 20 to 40% by weight.

Suitable surface-active agents are preferably addition products of 2 to 30 mol of ethylene oxide and/or 0 to 5 mol of propylene oxide with linear fatty alcohols with 8 to 22 carbon atoms, with fatty acids with 12 to 22 carbon atoms, with mono-, di- and/or trialkylphenols with 8 to 15 carbon atoms in the alkyl group and with (C₈-C₁₈)-alkylamines; secondary ether amines and alkoxylated secondary ether amine derivatives; (C₁₂-C₁₈)-fatty acid mono- and diesters of addition products of 1 to 30 mol of ethylene oxide with glycerol; glycerol mono- and diesters and sorbitan/sorbitol mono- and diesters of saturated and unsaturated fatty acids with 6 to 22 carbon atoms and their ethylene oxide addition products; addition products of 15 to 60 mol of ethylene oxide with castor oil and/or hydrogenated castor oil; polyol and in particular polyglycerol esters, e.g. polyglycerol polyricinoleate and polyglycerol poly(1 2-hydroxystearate); carboxamides, e.g. decanoic acid dimethylamide; high-molecular-weight silicone compounds, e.g. dimethylpolysiloxanes with an average molecular weight of 10 000 to 50 000 g/mol.

Also suitable are anionic surfactants, e.g. alkali metal and ammonium salts of linear or branched alkyl(ene) sulfates with 8 to 22 carbon atoms, (C₁₂-C₁₈)-alkylsulfonic acids and (C₁₂-C₁₈)-alkylarylsulfonic acids; bis(phenolsulfonic acid) ethers and their alkali metal or ammonium salts, isethionates, preferably cocoyl isethionate; naphthalenesulfonic acid and/or sulfosuccinates.

Suitable solid carriers are preferably clays, natural and synthetic bentonites, silica gels, calcium and magnesium silicates, titanium dioxide, aluminum, calcium or magnesium carbonate, ammonium, sodium, potassium, calcium or barium sulfate, coal, starch, modified starch, cellulose or cellulose derivatives, and their mixtures.

Preferred antifoam agents are fatty acid alkyl ester alkoxylates; organopolysiloxanes and their mixtures with microfine, optionally silanized, silicic acid; paraffins; waxes and microcrystalline waxes and their mixtures with silanized silicic acid. Mixtures of different antifoam agents, e.g. those from silicone oil, paraffin oil and/or waxes, are also advantageous. The antifoam agents are preferably bonded to a granular carrier which is soluble or dispersible in water.

Use is preferably made, as thickening agents, of hydrogenated castor oil; salts of long-chain fatty acids, preferably in amounts of up to 5% by weight, particularly preferably in amounts of 0.5 to 2% by weight, e.g. sodium, potassium, aluminum, magnesium and titanium stearates or the sodium and/or potassium salts of behenic acid; polysaccharides, especially xanthan gum, guar, agar, alginates and tyloses; carboxymethylcellulose and hydroxyethylcellulose; high-molecular-weight polyethylene glycol mono- and diesters of fatty acids; polyacrylates; polyvinyl alcohol and/or polyvinylpyrrolidone.

Suitable preservatives are, for example, phenoxyethanol, formaldehyde solution, parabens, pentanediol or sorbic acid.

The suspension concentrates are usually adjusted to a pH in the range 2 to 12, preferably 3 to 8, particularly preferably 6.5 to 7.5.

The use of the polymers provides the user with a large degree of freedom in the choice of his components. The suspensions show high compatibility of the components with one another (pesticides, adjuvants, dispersing agents, electrolytes, and the like) and high suspensibility (ability to remain suspended) of the components. The suspension concentrates show, on diluting, a markedly reduced tendency toward gel formation, phase separation, crystallization and/or sedimentation. In addition, the suspension concentrates show a markedly increased stability on storage.

The suspensibility of the suspensions is preferably greater than 85%, particularly preferably greater than 95%, especially preferably greater than 95%.

The suspensibility (ability to remain suspended) is in this instance defined as the percentage by weight of the suspended materials to the total weight of all materials.

The suspensibility (ability to remain suspended) can be determined according to the CIPAC method MT 161 (SC).

The invention also relates to the use of polymers which can be prepared by radical copolymerization of

A) acrylamidopropylmethylenesulfonic acid (AMPS) and/or its salts;

B) one or more macromonomers comprising
i) a terminal group which is capable of polymerizing and which is at least partially soluble in the reaction medium,
ii) a hydrophobic part which is hydrogen or a saturated or unsaturated, linear or branched, aliphatic, cycloaliphatic or aromatic (C₁-C₁₀₀)-hydrocarbon residue, and
iii) optionally a hydrophilic part based on polyalkylene oxides; and

C) optionally one or more other at least mono- or polyolefinically unsaturated oxygen-, nitrogen-, sulfur-, phosphorus-, chlorine- and/or fluorine-comprising comonomers,

for increasing the suspensibility of plant protection formulations present in the form of suspensions.

The suspensions are preferably suspension concentrates.

The following examples are intended to illustrate the subject matter of the invention in greater detail, without however limiting it thereto.

### EXAMPLE 1

Preparation of Polymer 1:

500 g of toluene were introduced into a 1 I Quickfit flask equipped with a stirrer, an internal thermometer, gas inlet pipes for nitrogen and ammonia gas, and a reflux condenser. Furthermore, 3.0 g of 2-acrylamido-2-methylpropanesulfonic acid (AMPS) were introduced and were neutralized with the equivalent amount of ammonia. 60.0 g of stearyl acrylate and 30.0 g of isopropanol were subsequently added. The contents of the flask were rendered inert with nitrogen while stirring and were heated to 70° C. using a heating bath. After reaching the temperature, 3.0 g of AIBN were added as initiator and the contents of the flask were heated to 80° C. while additionally flushing with nitrogen. The mixture was stirred at reflux at the stated temperature for 4 h. On completion of the reaction, the product was transferred to a rotary evaporator and the solverit was removed by vacuum distillation at approximately 50° C.

Preparation of Polymer 2:

As described in 1, however using 60.0 g of an ester formed from acrylic acid and (C₁₂₋₁₄)-fatty alcohol polyglycerol ethers with 7 EO units (Genapol® LA-070) in place of the stearyl acrylate.

Preparation of atrazine suspension concentrates with and without polymer:

a) Suspension concentrate with dispersing agent and without polymer

| Composition: | (% by weight) | (g) |
|---|---|---|
| Atrazine (99%) | 43.60 | 510.0 |
| Dispersing agent LFS ® | 2.10 | 25.0 |
| Defoamer SE 57 ® | 1.50 | 17.0 |
| Kelzan S ® (2% aq) | 7.20 | 85.0 |
| Ethylene glycol | 4.30 | 50.0 |
| Deionized water | 41.30 | 484.0 |

The suspensibility of the suspension was 84%. The suspensibility was the total suspensibility of all components as determined according to the CIPAC method MT 161 (SC).

b) Suspension concentrate with polymer 1 and without dispersing agent

| Composition: | (% by weight) | (g) |
|---|---|---|
| Atrazine (99%) | 43.60 | 510.0 |
| Defoamer SE 57 ® | 1.50 | 17.0 |
| Kelzan S ® (2% aq) | 7.20 | 85.0 |
| Polymer 1 | 2.10 | 1.17 |
| Ethylene glycol | 4.30 | 50.0 |
| Deionized water | 41.30 | 484.0 |

The suspensibility of the suspension was 88%. The suspensibility was the total suspensibility of all components as determined according to the CIPAC method MT 161 (SC).

c) Suspension concentrate with polymer 1 and with dispersing agent

| Composition: | (% by weight) | (g) |
|---|---|---|
| Atrazine (99%) | 43.60 | 510.0 |
| Dispersing agent LFS ® | 2.00 | 23.80 |
| Defoamer SE 57 ® | 1.50 | 17.0 |
| Kelzan S ® (2% aq) | 7.20 | 85.0 |
| Polymer 1 | 0.10 | 1.17 |
| Ethylene glycol | 4.30 | 50.0 |
| Deionized water | 41.30 | 484.0 |

The suspensibility of the suspension was 96%. The suspensibility was the total suspensibility of all components as determined according to the CIPAC method MT 161 (SC). This result confirms the synergistic effect between polymer and dispersing agent. It is seen that the suspensibility was greatly increased by the addition of only 0.1% by weight of polymer.

d) Suspension concentrate with polymer 2 and with dispersing agent

| Composition: | (% by weight) | (g) |
|---|---|---|
| Atrazine (99%) | 43.60 | 510.0 |
| Dispersing agent LFS ® | 2.00 | 23.80 |
| Defoamer SE 57 ® | 1.50 | 17.0 |
| Kelzan S ® (2% aq) | 7.20 | 85.0 |
| Polymer 2 | 0.10 | 1.17 |
| Ethylene glycol | 4.30 | 50.0 |
| Deionized water | 41.30 | 484.0 |

The suspensibility of the suspension was 98%. The suspensibility was the total suspensibility of all components as determined according to the CIPAC method MT 161 (SC). This result confirms the synergistic effect between polymer and dispersing agent. It is seen that the suspensibility was greatly increased by the addition of only 0.1% by weight of polymer.

Chemical description of the commercial products used:

| | |
|---|---|
| Dispersing agent LFS ® | poly(arylalkyl)phenol polyethylene glycol |
| | phosphoric acid ester |
| Defoamer SE 57 ® | Silicone defoamer, Wacker |
| Kelzan S ® (2% aq) | Xanthan gum thickener |

1. An aqueous plant protection formulation in the form of a suspension comprising at least one polymer prepared by radical copolymerization of
A) acrylamidopropylmethylenesulfonic acid (AMPS) and/or its salts;
B) one or more macromonomers according to formula (1)
R¹—Y—(R²—O)ₓ(R⁴—O)_{z}—R³ (1)
wherein
R¹ is a vinyl, allyl, acryloyl, methacryloyl, senecioyl or crotonyl residue;
R² and R⁴ are, independently of one another, (C₂-C₄)-alkylene;
x and z are, independently of one another, a whole number between 0 and 500, with x+z greater than or equal to 1;
Y is O, S, PH or NH; and
R³ is hydrogen or a saturated or unsaturated, linear or branched, aliphatic, cycloaliphatic or aromatic (C₁-C₁₀₀)-hydrocarbon residue, and
C) optionally one or more other at least mono- or polyolefinically unsaturated oxygen-, nitrogen-, sulfur-, phosphorus-, chlorine- and/or fluorine containing comonomers.

2. A plant protection formulation as claimed in claim 1, wherein the comonomer A) is the sodium salt and/or ammonium salt of acrylamidopropylmethylenesulfonic acid (AMPS).

3. A plant protection formulation as claimed in claim 1, wherein
R¹ is an acryloyl or methacryloyl residue;
R² and R⁴ are, independently of one another, C₂-alkylene or C₃-alkylene;
x and z are, independently of one another, an integer between 0 and 50, with x+z greater than or equal to 1;
R³ is an aliphatic (C₄-C₂₂)-alkyl or -alkenyl residue, a phenyl residue; a (C₁-C₂₂)-alkylphenyl residue, a poly((C₁-C₂₂)-alkyl)phenyl residue, or a polystyrylphenyl residue.

4. A plant protection formulation as claimed in claim 3, wherein the R³ residue is a 2,4,6-tris(sec-butyl)phenyl residue or 2,4,6-tris(1-phenylethyl)phenyl residue.

5. A plant protection formulation as claimed in claim 1, wherein the least one polymer is prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid;
B) one or more macromonomers selected from the group consisting of esters formed from methacrylic acid or acrylic acid, compounds of the formula (2)
HO—(CH₂—CH₂—O)ₓ—R³ (2)
wherein x is a number between 1 and 50, and R³ is a (C₁₀-C₂₂)-alkyl residue; and
C) optionally one or more comonomers selected from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate.

6. A plant protection formulation as claimed in claim 1, wherein the one or more macromonomers B) are esters formed from acrylic acid or methacrylic acid or alkyl ethoxylates selected from the group consisting of
(C₁₀-C₁₈)-fatty alcohol polyglycol ethers with 8 EO units, C₁₁-oxo alcohol polyglycol ethers with 8 EO units, (C₁₂-C₁₄)-fatty alcohol polyglycol ethers with 7 EO units, (C₁₂-C₁₄)-fatty alcohol polyglycol ethers with 11 EO units, (C₁₆-C₁₈)-fatty alcohol polyglycol ethers with 8 EO units, (C₁₆-C₁₈)-fatty alcohol polyglycol ethers with 15 EO units, (C₁₆-C₁₈)-fatty alcohol polyglycol ethers with 11 EO units, (C₁₆-C₁₈)-fatty alcohol polyglycol ethers with 20 EO units, (C₁₆-C₁₈)-fatty alcohol polyglycol ethers with 25 EO units, (C₁₈-C₂₂)-fatty alcohol polyglycol ethers with 25 EO units, iso(C₁₆-C₁₈)-fatty alcohol polyglycol ethers with 25 EO units and/or and C₂₂-fatty alcohol polyglycol ethers with 25 EO units.

7. A plant protection formulation as claimed in claim 1, wherein the at least one polymer is prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid;
B) one or more macromonomers selected from the group consisting of esters formed from methacrylic acid or acrylic acid, and compounds of the formula (3)
HO—(CH₂—CH₂—O)ₓ—R³ (3)
wherein
x is a number between 1 and 50, and R³ is a poly((C₁-C₂₂)-alkyl)phenyl residue, or a tris(styryl)phenyl residue; and
C) optionally one or more comonomers selected from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate.

8. A plant protection formulation as claimed in claim 1, wherein the proportion of macromonomers B) in the at least one polymer is 50.1 to 99.9% by weight.

9. A plant protection formulation as claimed claim 1, wherein the proportion of macromonomers B) in the at least one polymer is 0.1 to 50%.

10. A plant protection formulation as claimed in claim 1, wherein the number-average molecular weight of the at least one polymer is 1000 to 20 000 000 g/mol.

11. A plant protection formulation as claimed in claim 1, wherein the at least one polymer is crosslinked.

12. A plant protection formulation as claimed claim 1, wherein the radical copolymerization is a precipitation polymerization reaction.

13. A suspension concentrate comprising a plant protection formulation as claimed in claim 1.

14. A suspension concentrate as claimed in claim 13, wherein the water content, of a ready-mix formulation, is 10 to 50% by weight.

15. A suspension concentrate as claimed in claim 13, wherein the proportion of the at least one polymer, in a ready-mix formulation, is 0.01 to 10% by weight.

16. A suspension concentrate as claimed in claim 1, further comprising at least one dispersant.

17. A suspension concentrate as claimed in claim 16, wherein the at least one dispersant is selected from the group consisting of phosphoric acid esters and phosphoric acid ester salts of fatty alcohols and fatty alcohol alkoxylates, methoxycarbonylcellulose; methylcellulose; starch; alginates; sulfonated naphthalene-formaldehyde condensates; lignosulfonates; polyvinylpyrrolidone and polyvinyl alcohol.

18. A suspension concentrate as claimed in claim 13, comprising, with in a ready-mix suspension concentrate, 0.5 to 10% by weight of the at least one dispersant and 0.01 to 2.5% by weight, pre of polymers of the at least one polymer.

19. A suspension concentrate as claimed in claim 13, further comprising at least one pesticide and wherein the proportion of the at least one pesticide in a ready-mix suspension concentrate, is 10-90% by weight.

20. A plant protection formulation as claimed in claim 1, further comprising at least one pesticide which is sparingly soluble in water.

21. A plant protection formulation as claimed in claim 1, further comprising at least one pesticide which is sparingly soluble in water and at least one pesticide which is readily soluble in water.

22. A method for increasing the suspensibility of a plant protection formulation in the form of a suspension comprising the step of adding to the plant formulation at least one polymer prepared by radical copolymerization of
A) acrylamidopropylmethylenesulfonic acid (AMPS) and/or its salts;
B) one or more macromonomers according to formula (1)
R¹—Y—(R²—O)ₓ(R⁴—O)_{z}—R³ (1)
wherein
R¹ is a vinyl, allyl, acryloyl, methacryloyl, senecioyl or crotonyl residue;
R² and R⁴ are, independently of one another, (C₂-C₄)-alkylene;
x and z are, independently of one another, a whole number between 0 and 500, with x+z greater than or equal to 1;
Y is O, S, PH or NH, and
R³ is hydrogen or a saturated or unsaturated, linear or branched, aliphatic, cycloaliphatic or aromatic (C₁-C₁₀₀)-hydrocarbon residue, and
C) optionally one or more other at least mono- or polyolefinically unsaturated oxygen-, nitrogen-, sulfur-, phosphorus-, chlorine- and/or fluorine containing comonomers.

23. The method as claimed in claim 22, wherein the plant protection formulation is a suspension concentrate.

24. A plant protection formulation as claimed in claim 1, wherein Y is oxygen.

25. A plant protection formulation as claimed in claim 1, wherein R³ is a (C₁-C₃₀)-hydrocarbon residue.

26. A plant protection formulation as claimed in claim 3, wherein R³ is a (C₁₀-C₂₂)-alkyl or -alkenyl residue.

27. A plant protection formulation as claimed in claim 3, wherein R³ is a sec-butyl- or n-butylphenyl residue.

28. A plant protection formulation as claimed in claim 3, wherein R³ is a tris(sec-butyl)phenyl residue or tris(n-butyl)phenyl residue.

29. A plant protection formulation as claimed in claim 3, wherein R³ is a tristyrylphenyl residue.

30. A plant protection formulation as claimed in claim 5, wherein the comonomer A) is the ammonium salt of acrylamidopropylmethylenesulfonic acid.

31. A plant protection formulation as claimed in claim 5, wherein the one or more macromonomers B) is an ester formed from methacrylic acid.

32. A plant protection formulation as claimed in claim 5, wherein x is between 5 and 30.

33. A plant protection formulation as claimed in claim 7, wherein the comonomer A) is the ammonium salt of acrylamidopropylmethylenesulfonic acid.

34. A plant protection formulation as claimed in claim 7, wherein the one or more macromonomers is an ester formed from methacrylic acid.

35. A plant protection formulation as claimed in claim 7, wherein x is between 5 and 30.

36. A plant protection formulation as claimed in claim 7, wherein R³ is a tris(sec-butyl)phenyl residue or tris(n-butyl)phenyl residue.

37. A plant protection formulation as claimed in claim 7, wherein R³ is a 2,4,6-tris(sec-butyl)phenyl residue.

38. A plant protection formulation as claimed in claim 7, wherein R³ is a 2,4,6-tris(1-phenylethyl )phenyl residue.

39. A plant protection formulation as claimed in claim 1, wherein the proportion of macromonomers B) in the at least one polymer is 70 to 95% by weight.

40. A plant protection formulation as claimed in claim 1, wherein the proportion of macromonomers B) in the at least one polymer is 80 to 94% by weight.

41. A plant protection formulation as claimed claim 1, wherein the proportion of macromonomers B) in the at least one polymer is 5 to 25%.

42. A plant protection formulation as claimed claim 1, wherein the proportion of macromonomers B) in the at least one polymer is 6 to 20%.

43. A plant protection formulation as claimed in claim 1, wherein the number-average molecular weight of the at least one polymer is 20 000 to 5 000 000 g/mol.

44. A plant protection formulation as claimed in claim 1, wherein the number-average molecular weight of the at least one polymer is 50 000 to 1 500 000 g/mol.

45. A plant protection formulation as claimed in claim 12, wherein the precipitation polymerization reaction occurs in tert-butanol.

46. A suspension concentrate as claimed in claim 13, wherein the water content, of a ready-mix formulation, is 10 to 45% by weight.

47. A suspension concentrate as claimed in claim 13, wherein the water content, of a ready-mix formulation, is 25 to 45% by weight.

48. A suspension concentrate as claimed in claim 13, wherein the proportion of the at least one polymer, in a ready-mix formulation, is 0.01 to 5% by weight.

49. A suspension concentrate as claimed in claim 16, wherein the at least one dispersant is a poly(arylalkyl)phenol polyethylene glycol phosphoric acid ester or a tristyryl polyglycol ether phosphate.

50. A suspension concentrate as claimed in claim 13, comprising, in a ready mix suspension concentrate, 0.5 to 5% by weight of the at least one dispersant and 0.025 to 1% by weight of the at least one polymer.

51. A suspension concentrate as claimed in claim 13, further comprising at least one pesticide and wherein the proportion of the at least one pesticide, in a ready-mix suspension concentrate, is 30 to 60% by weight.

52. A suspension concentrate as claimed in claim 13, further comprising at least one pesticide and wherein the proportion of the at least one pesticide, in a ready-mix suspension concentrate, is 40 to 50% by weight.

53. The method as claimed in claim 22, wherein Y is oxygen.

54. The method as claimed in claim 22, wherein R³ is a (C₁-C₃₀)-hydrocarbon residue.
